(19) United States
(12) Patent Application Publication
(10) Pub. No.: US 2007/0290097 A1
(43) Pub. Date: Dec. 20, 2007

(54) Vertical take-off and landing aircraft

(76) Inventor: Masatsugu Ishiba, Gotenba-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/206,909

(22) Filed: Aug. 19, 2005

(30) Foreign Application Priority Data
Aug. 19, 2004 (JP) 2004-239645

(51) Int. Cl. B64C 29/00

(52) U.S. Cl. 244/12.1

(57) ABSTRACT

An object of the invention is to prevent non-uniformity in the temperature distribution from occurring in a tip turbine fan in a vertical take-off and landing aircraft that uses the tip turbine fan as a source of thrust. In a vertical take-off and landing aircraft provided with a tip turbine fan in which a fan is rotated by blowing, in an annular turbine chamber provided around a rotation shaft of the fan at the center, compressed gas to a tip turbine attached to the fan to enable vertical take-off and landing, three or more compressed gas intake ports for supplying compressed gas to said turbine chamber are provided at regular intervals along the circumference of the turbine chamber.

### BACKGROUND OF THE INVENTION

1. Field of the Invention

The present invention relates to a vertical take-off and landing aircraft that is adapted to perform vertical takeoff and landing.

2. Description of Related Art

In a conventional helicopter that can take off and land vertically, thrust is controlled by collective pitch control in which the pitch angle of the main rotor is changed. In the collective pitch control, the engine speed is kept constant, and thrust is adjusted only by changing the pitch angle of the main rotor. However, a change in the pitch angle causes a change in the air resistance of the main rotor, which, in turn, causes a change in the engine load. Consequently, the engine speed may change in some cases, which sometimes leads to a change in the altitude of the helicopter. In addition, the collective pitch control requires the operator to have expertise in the operation, and it is necessary for the operator to adjust the thrust while predicting changes in the thrust.

In the case of helicopters and the like equipped with a large size main rotor, since the moment of inertia of the main rotor is high, it is possible to restrict the aforementioned changes in the engine speed to some extent. On the other hand, a technology of controlling pitch and roll by a trough shaped air deflector has been known (see, for example, International publication No. WO00/040464).

A technology concerning a tip turbine fan that may be applied to vertical take-off and landing aircrafts has been disclosed (see, for example, Japanese Patent Application Laid-Open No. 6-272619). According to this disclosed technology, it is possible to prevent leakage of fuel gas from a fuel gas passage of a tip turbine to an air passage of a compressor from occurring.

In the case where a tip turbine fan is used as a source of thrust in a vertical take-off and landing aircraft, the energy for rotationally driving the fan is obtained from compressed gas. Specifically, the fan is rotated by compressed gas or the like by way of a tip turbine attached to the fan to generate the thrust of the vertical take-off and landing aircraft. In this process, the portion for supplying the compressed gas to the tip turbine is heated to a high temperature, and non-uniformity in the temperature distribution occurs in the tip turbine fan and the fan case. This may possibly result in a failure at a portion such as a labyrinth portion of the fan for which dimensional tolerance is small. If requirements for the dimensional tolerance are loosened, there is a possibility that the thrust of the vertical take-off and landing aircraft may be decreased.

If one tip turbine of a vertical take-off and landing aircraft equipped with a plurality of tip turbine fans stops for some reason, the rotation moment generated by the tip turbine fans will get out of balance. As a result, it may become difficult to keep stability in the attitude of the vertical take-off and landing aircraft. If the other tip turbine fans are stopped to keep balance, a decrease in the thrust of the vertical take-off and landing aircraft may result.

When a cyclic pitch control is applied to a tip turbine to control the attitude of a vertical take-off and landing aircraft, the attitude control response is low, and it may sometimes be difficult to control the vertical take-off and landing aircraft immediately to assume the attitude the operator demands.

### SUMMARY OF THE INVENTION

In view of the above-described problems, the present invention has as an object to reduce, in a vertical take-off and landing aircraft that uses a tip turbine fan(s) as a source of thrust, the degree of non-uniformity in the temperature distribution in the tip turbine fan, to ensure stabilization in the attitude of a vertical take-off and landing aircraft in the situation in which one tip turbine fan stops, and to control the attitude of a vertical take-off and landing aircraft with high responsiveness.

In the present invention, to achieve the above objects, a consideration has been made on the number of intake ports for introducing compressed gas into a tip turbine fan and on the intervals of their arrangement on the turbine chamber. Specifically, according to the present invention, in a vertical take-off and landing aircraft provided with a tip turbine fan in which a fan is rotated by blowing, in an annular turbine chamber provided around a rotation shaft of the fan at the center, compressed gas to a tip turbine attached to the fan to enable vertical take-off and landing, two or more compressed gas intake ports for supplying compressed gas to said turbine chamber are provided at regular intervals along the circumference of the turbine chamber.

In order to create a larger thrust to the vertical take-off and landing aircraft, the compressed gas supplied to the tip turbine fan is highly compressed and has a relatively high temperature. By providing tree or more compressed gas intake ports along the circumference of the turbine chamber at equal intervals, a high temperature distribution about the compressed gas intake ports is formed uniformly in the turbine chamber and its periphery. Consequently, the temperature distribution in the tip turbine fan becomes more uniform. Thus, it is possible to prevent failures due to changes in the temperature in the portions for which dimensional tolerance is small, such as labyrinth portion of the fan, from occurring, or it is possible to avoid a decrease in the thrust of the vertical take-off and landing aircraft that might be caused if requirements for the dimensional tolerance are loosened to prevent such failures from occurring beforehand. The reason why the number of the compressed gas intake ports is to be three or more is that if the number is one or two, the intervals between the compressed gas intake ports are too large to realize sufficient uniformity in the temperature distribution in the tip turbine fan. In this and other aspects of the present invention that will be described in the following, compressed gas may be compressed air.

In another aspect of the present invention, to achieve the above objects, a consideration has been made on the arrangement and the direction of rotation of the fans in one tip turbine fan. More specifically, according to the present invention, in a vertical take-off and landing aircraft provided with tip turbine fans in each of which a fan is rotated by blowing, in an annular turbine chamber provided around a rotation shaft of the fan at the center, compressed gas to a tip turbine attached to the fan to enable vertical take-off and landing, in each of said plurality of tip turbine fans, an even number of sets of fans and tip turbines are provided, said plurality of tip turbines being arranged in series along the flow of compressed gas in the turbine chamber, and rotation directions of the fans to which the respective tip turbines are attached being alternately opposite.

By providing in one tip turbine fan an even number of sets of fans and tip turbines attached thereto and making the rotation directions of fans alternately opposite, rotation moment generated by the fans can be cancelled. Thus, rotation moment of the vertical take-off and landing aircraft generated in one tip turbine fan can be reduced. Therefore, even when one of a plurality of tip turbine fans stops for some reason, rotation moment is not generated in the vertical take-off and landing aircraft, and it is possible to continue flight without stopping the rest of the tip turbine fans. In other words, it is possible to avoid the situation where stabilization of the attitude of the vertical take-off and landing aircraft becomes difficult, and to prevent a decrease in the thrust of the vertical take-off and landing aircraft that would be caused if the tip turbine fan was stopped to reduce rotation moment for stabilization.

Compressed gas supplied to the turbine chamber through the compressed gas intake ports creates lift in the tip turbines in the turbine chamber one after another to cause the fans to rotate. Therefore, if the angles of attack between the respective tip turbines and the flow of compressed gas are the same, the more downstream in the turbine chamber the position of a tip turbine is, the smaller the lift created therein by the compressed gas flow is, and the smaller the rotation moment generated by the fan to which that tip turbine is attached is. In this case, consequently, there are variations in the rotation moments generated by the fans, and rotation moment generated by the tip turbine fan as a whole that will cause the vertical take-off and landing aircraft to rotate becomes large. In view of this, in the above-described vertical take-off and landing aircraft, in each of said tip turbine fans, the more downstream a tip turbine, among said multiple tip turbines, is located in the gas flow in said turbine chamber, the larger the angle of attack between that tip turbine and the compressed gas flow may be.

In still another aspect of the present invention, to achieve the above objects, a consideration has been made on thrust generated by discharge of compressed gas that has been supplied to the turbine chamber. Specifically, according to the present invention, in a vertical take-off and landing aircraft provided with a tip turbine fan in which a fan is rotated by blowing, in an annular turbine chamber provided around a rotation shaft of the fan at the center, compressed gas to a tip turbine attached to the fan to enable vertical take-off and landing, a plurality of compressed gas intake ports for supplying compressed gas to said turbine chamber are provided along the circumference of the turbine chamber, compressed gas outlet ports corresponding to said compressed gas intake ports for discharging compressed gas in the turbine chamber are provided on the turbine chamber, and the vertical take-off and landing aircraft includes compressed gas quantity control apparatuses that control the quantity of compressed gas supplied to said turbine chamber through said plurality of compressed gas intake ports respectively.

The intrinsic task of the compressed gas supplied to the turbine chamber is fulfilled when it causes the fan(s) to rotate by creating lift in the tip turbine(s) In the vertical take-off and landing aircraft described above, however, the compressed gas discharged from the compressed gas outlet ports after it has created lift in the tip turbine(s) is utilized for controlling the attitude of the vertical take-off and landing aircraft. Since the compressed gas quantity control apparatus can control the compressed gas quantity with high responsiveness, it is possible to control the attitude of the vertical take-off and landing aircraft to an attitude the operator demands more quickly than in the case where the tip turbine is controlled by so-called cyclic pitch control.

In the case where the above-described vertical take-off and landing aircraft further comprises a compressed gas tank that stores compressed gas and compressed gas supply passages one end of each of which is connected to said compressed gas tank, and the other end of each of which is connected to each of said compressed gas intake ports, for supplying compressed gas from said compressed gas tank to said compressed gas intake port, each of said compressed gas control apparatuses may have a compressed gas control valve which is provided in each of said compressed gas supply passages for controlling compressed gas flow in the compressed gas flow supply passage.

In this case, it is possible to control the quantity of the compressed gas supplied to the turbine chamber by controlling the degree of opening of the compressed gas control valves.

In the above-described vertical take-off and landing aircraft, a de Laval nozzle may be provided at said compressed gas outlet port. With this feature, it is possible to avoid unnecessary diffusion of the compressed gas discharged from the compressed gas outlet ports. Thus, thrust generated by the compressed gas can be utilized more effectively in controlling the attitude of the vertical take-off and landing aircraft.

The above and other objects, features and advantages of the present invention will become more readily apparent to those skilled in the art from the following detailed description of preferred embodiments of the present invention taken in conjunction with the accompanying drawings.

### BRIEF DESCRIPTION OF THE DRAWINGS

FIG. 1 is a first drawing schematically showing a vertical take-off and landing aircraft according to an embodiment of the present invention.

FIG. 2 is a second drawing schematically showing a vertical take-off and landing aircraft according to an embodiment of the present invention.

FIG. 3 is a third drawing schematically showing a vertical take-off and landing aircraft according to an embodiment of the present invention.

FIG. 4 shows the structure of a tip turbine fan equipped in the vertical take-off and landing aircraft according to a first embodiment of the present invention.

FIG. 5 shows the tip turbine fan equipped in the vertical take-off and landing aircraft according to the first embodiment of the present invention as viewed from above.

FIG. 6 schematically shows a vertical take-off and landing aircraft according to a second embodiment of the present invention.

FIG. 7 shows the structure of a tip turbine fan equipped in a vertical take-off and landing aircraft according to a second embodiment of the present invention.

FIG. 8 shows a system configuration concerning compressed air supply in a tip turbine fan equipped in a vertical take-off and landing aircraft according to a third embodiment of the present invention.

FIG. 9 shows the structure of the tip turbine fan shown in FIG. 8.

FIG. 10 shows the structure of a tip turbine fan equipped in a vertical take-off and landing aircraft according to a fourth embodiment of the present invention.

FIG. 11 illustrates ground effect in a vertical take-off and landing aircraft according to fifth embodiment of the present invention.

FIG. 12 shows changes in the length of a shock absorber and changes in the thrust of a tip turbine fan upon landing of the vertical take-off and landing aircraft according to the fifth embodiment of the present invention.

FIG. 13 shows changes in the length of a shock absorber and changes in the thrust of a tip turbine fan upon take-off of the vertical take-off and landing aircraft according to the fifth embodiment of the present invention.

### DESCRIPTION OF THE PREFERRED EMBODIMENTS

In the following, embodiments of the vertical take-off and landing aircraft according to the present invention will be described with reference to the drawings.

### Embodiment 1

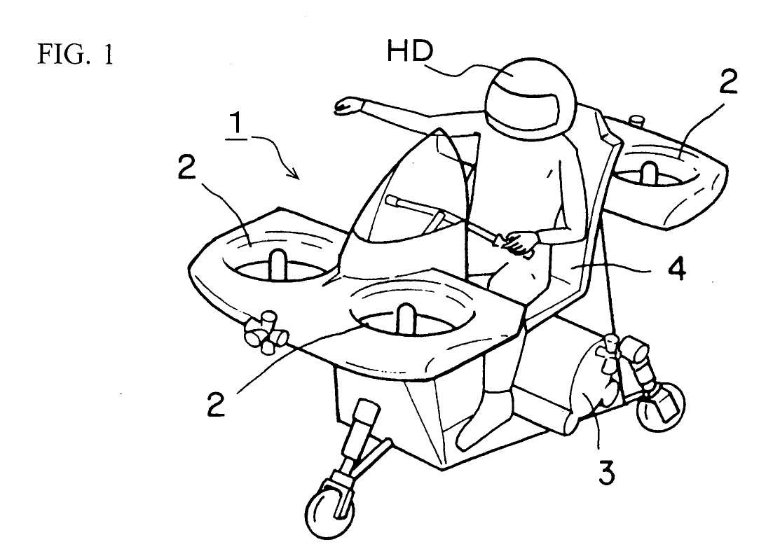

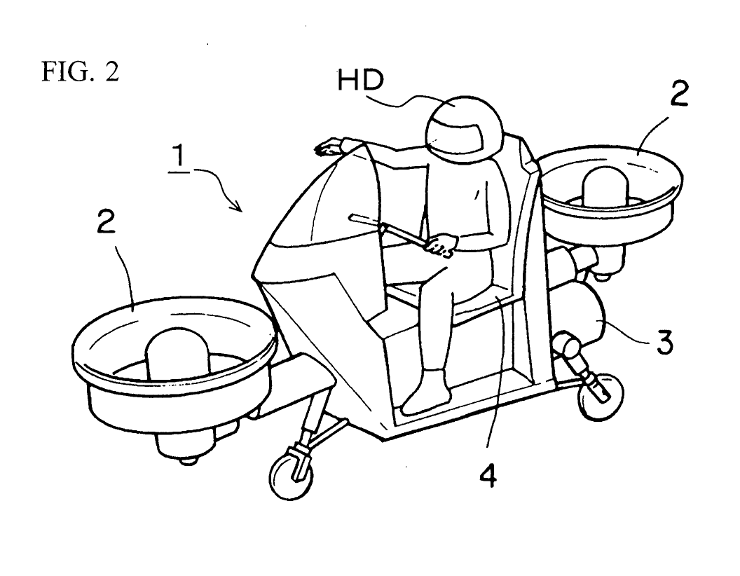

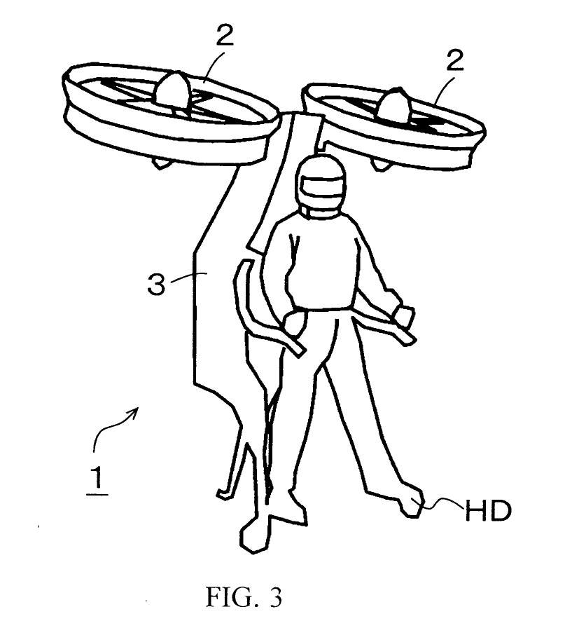

FIGS. 1 to 3 schematically show the structure of vertical take-off and landing aircrafts 1 according to the present invention. The embodiment that will be described below is to be applied to these vertical take-off and landing aircrafts 1. The vertical take-off and landing aircraft 1 shown in FIG. 1 is equipped with four tip turbine fans 2, two of which are provided in the front side of the operator HD and the other two of which are provided in the rear side of the operator HD. Compressed air used as drive source of these tip turbine fans 2 is stored in a compressed air tank 3 disposed below the operator seat 4 for the operator HD. The vertical take-off and landing aircraft 1 shown in FIG. 2 is equipped with two turbine fans 2, one of which is provided in the front side of the operator HD and the other of which is provided in the rear side of the operator HD. Compressed air used as drive source of these tip turbine fans 2 is stored in a compressed air tank 3 disposed in the rear of the operator seat 4 for the operator HD and below the rear side tip turbine fans 2. The vertical take-off and landing aircraft 1 shown in FIG. 3 can be operated by the operator HD in a substantially standing position. This vertical take-off and landing aircraft 1 is equipped with two tip turbine fans 2 disposed above the operator HD, one of which is in the left side and the other is in the right side. Compressed air used as drive source of these tip turbine fans 2 is stored in a compressed air tank 3 disposed in back of the operator HD.

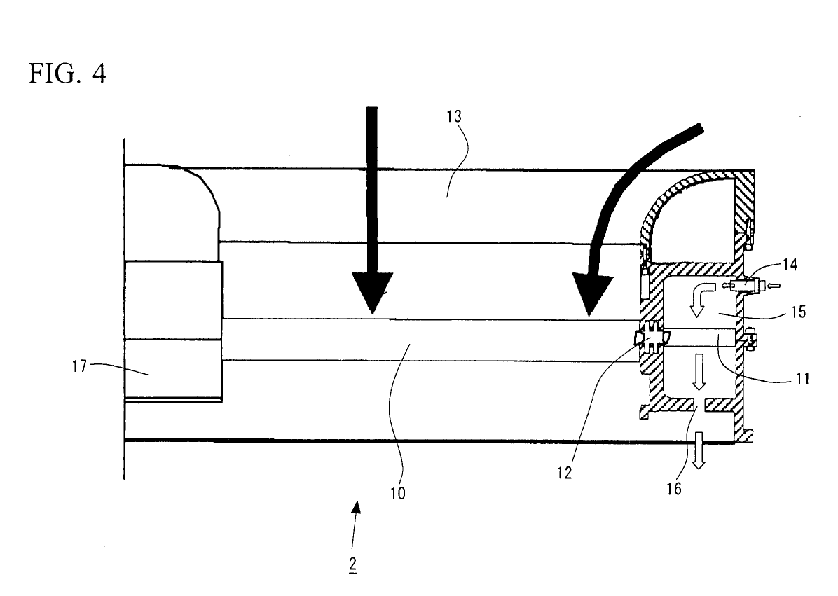

The structure of the tip turbine fan 2 in the first embodiment will be described with reference to FIG. 4. The tip turbine fan 2 is composed basically of a fan 10 adapted to rotate about a main shaft 17 at the center, a tip turbine 11 attached to the tip end of the fan 10 through a labyrinth portion 12 and a fan case 13 that houses these portions. The tip turbine 11 is disposed in a turbine chamber 15 having an annular configuration surrounding the main shaft 17 at the center. Compressed air is supplied to the turbine chamber 15 from the compressed air tank 3 via compressed air intake ports 14. The compressed air is blown to the tip turbine 11 in the turbine chamber 15, so that lift is generated in the tip turbine 11, and the fan 10 is caused to rotate about the main shaft 17.

The outline arrows in FIG. 4 indicate the flow of compressed air, and the solid arrows indicate the air flow generated by rotation of the fan 10. The air flows indicated by the solid arrows create an ascending force in the vertical take-off and landing aircraft 1. The compressed air supplied to the turbine chamber 15 is blown to the tip turbine 11, and thereafter exhausted to the exterior of the turbine chamber 15 via compressed air outlet ports 16.

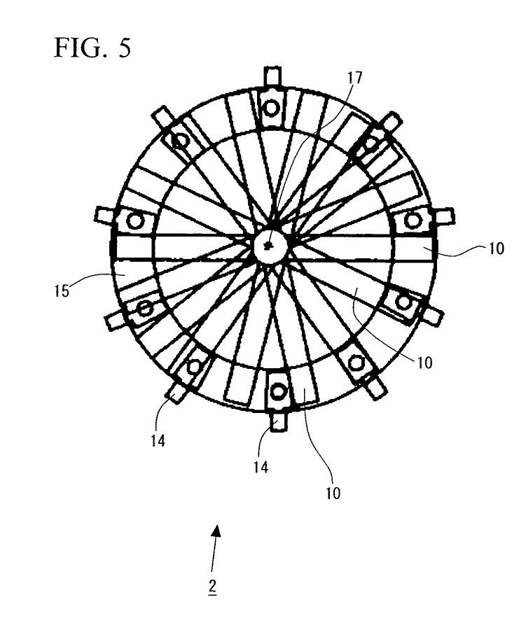

FIG. 5 shows the tip turbine fan 2 as seen from above. In this embodiment, ten compressed air intake ports for supplying compressed air into the turbine chamber are arranged at regular intervals along the circumference of the turbine chamber 15 which is configured annually about the main shaft 17 at the center. To create a high lift by means of the tip turbine 11, the compressed air supplied to the turbine chamber 15 is compressed to a relatively high pressure, and its temperature is high. In view of this, the compressed air intake ports 14 are arranged in the manner shown in FIG. 5. By this arrangement, the temperature of the tip turbine fan 2 as a whole is increased by heat energy of the compressed air relatively uniformly. In other words, temperature variations in the temperature distribution around the compressed air intake ports 14 can be made small.

Consequently, in designing the tip turbine fan 2, it is possible to set smaller margins against the thermal deformation of components of the tip turbine fan 2 that might be caused by non-uniformity in the temperature distribution. For example, it is possible to reduce the dimensional tolerance of a gap in the labyrinth portion 12 to increase the efficiency in creating lift in the tip turbine 11. To put it differently, it is possible to prevent, more reliably, contact between parts in the labyrinth portion 12 due to thermal deformation.

### Embodiment 2

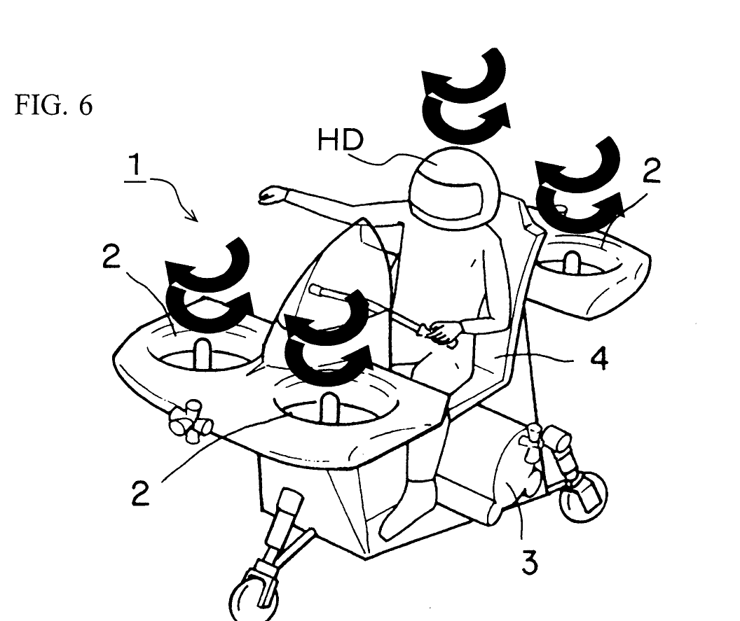

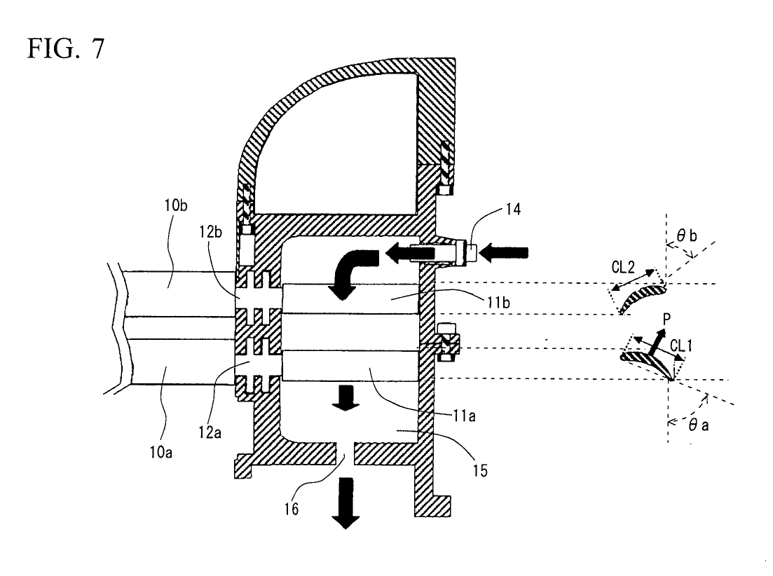

FIG. 6 schematically shows a vertical take-off and landing aircraft according to the second embodiment. The basic structure of the vertical take-off and landing aircraft 1 shown in FIG. 6 is the same as the vertical take-off and landing aircraft shown in FIG. 1. What is different is that the tip turbine fan 2 of the vertical take-off and landing aircraft shown in FIG. 6 has two fans that is arranged in series one above the other. The rotation directions of fans in each tip turbine fan 2 are opposite to each other as indicated by solid arrows in FIG. 6. A more detailed structure of the tip turbine fan 2 of this embodiment is shown in FIG. 7. In FIG. 7, elements the same as the elements of the tip turbine fan 2 shown in FIG. 4 are designated by the same reference numerals, and detailed descriptions thereof will be omitted.

A difference between the tip turbine fan 2 shown in FIG. 7 and the tip turbine fan 2 shown in FIG. 4 resides in that the former has two fans (10a and 10b). These fans will be referred to as the first fan 10a and the second fan 10b respectively. Attached to the first fan 10a, through a first labyrinth portion 12a, is a first tip turbine 11a. Attached to the second fan 10b, through a second labyrinth portion 12b, is a second tip turbine 11b.

In the tip turbine chamber 15, the first tip turbine 11a and the second tip turbine 11b are arranged in series along the flow of compressed air, where the first tip turbine 11a is disposed downstream of the second tip turbine 11b. Thus, the compressed air supplied to the turbine chamber 15 through compressed air intake ports 14 firstly generates lift in the second tip turbine 11b to cause the second fan 10b to rotate and then generates lift in the first tip turbine 11a to cause the first fan 10a to rotate.

In the right side of the tip turbines in FIG. 7, cross sections of the corresponding tip turbines are shown. As shown in FIG. 7, the first tip turbine 11a and the second tip turbine 11b have wing-like shapes, and the inclinations of the normal lines of the tip turbines relative to the flow of compressed air are opposite to each other. Consequently, the directions of rotation of the first fan 10a and the second fan 10b about the main shaft 17 are opposite to each other. Thus, rotation moments about the main shaft 17 generated by the first fan 10a and the second fan 10b cancel each other out.

By making the rotation moments about the main shaft 17 generated respectively by the first fan 10a and the second fan 10b as equal as possible, the rotation moment generated by one tip turbine fan 2 can be made as small as possible. To this end, the chord length CL1 of the first tip turbine 11a is designed to be larger than the chord length CL2 of the second tip turbine 11b, and the angle of attack θa of the first tip turbine 11a is designed to be larger than the angle of attack θb of the second tip turbine 11b. The above design has been adopted taking into consideration the fact that the compressed air supplied to the turbine chamber 15 firstly works on the second tip turbine 11b, and the compressed air has lost a part of its energy when it works on the first tip turbine 11a. In this way, it is possible to generate lift P in the first tip turbine 11a more efficiently.

In the vertical take-off and landing aircraft 1 equipped with the tip turbine fans 2 having the above-described structure, even when one of the tip turbine fans 2 stops for some reason, it is possible to continue the flight by maintaining driving of the remaining tip turbine fans 2 without inviting instability of the attitude of the vertical take-off and landing aircraft 1 due to a rotation moment. In other words, it is possible to continue the flight of the vertical take-off and landing aircraft 1 without intentionally stopping the still running tip turbine fans 2 to cancel the rotation moment generated by the stoppage of one tip turbine fan 2.

### Embodiment 3

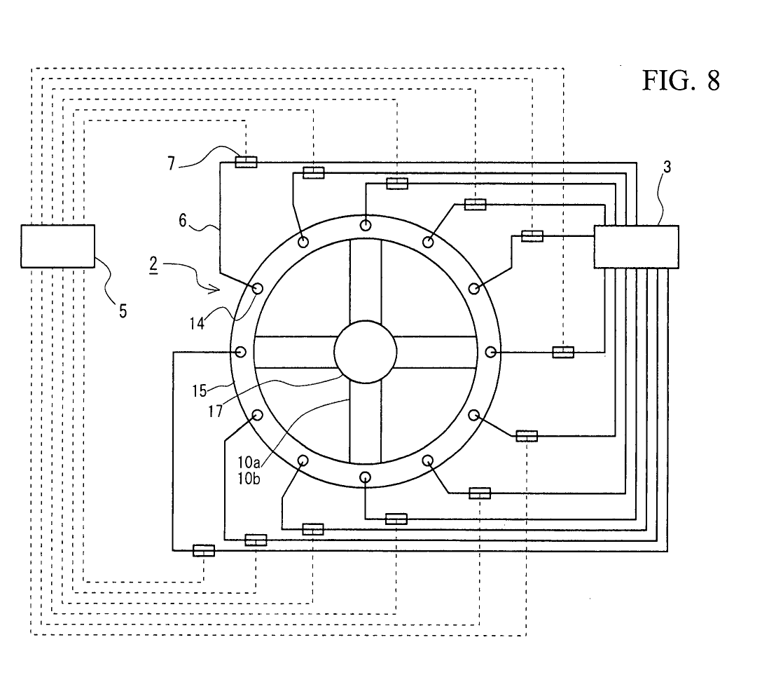

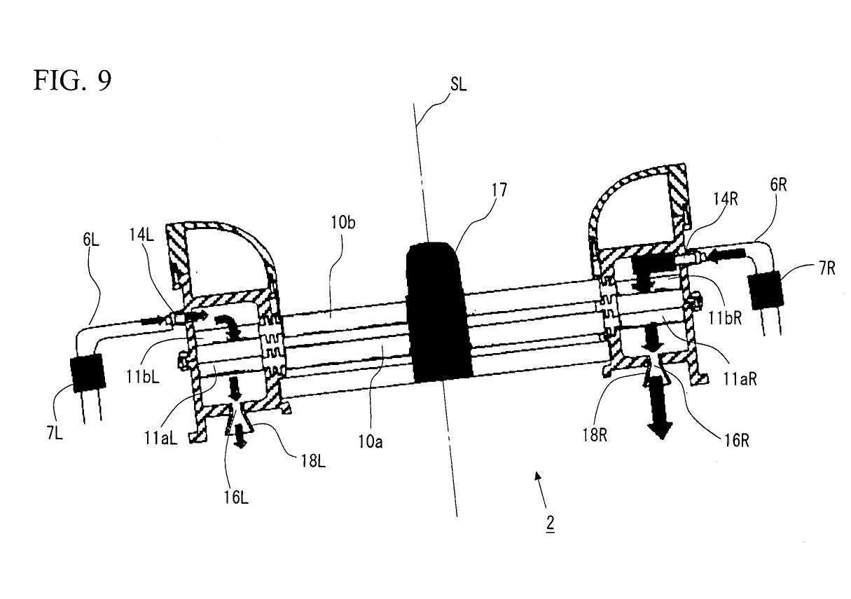

FIG. 8 shows the structure of a system related to compressed air supply in a tip turbine fan 2 of a vertical take-off and landing aircraft 1 according to this embodiment. FIG. 9 shows the structure of the tip turbine fan 2 in detail. The specific structure of the tip turbine fan 2 is the same as that shown in FIG. 7, and the same components are designated by the same reference numerals, and detailed descriptions thereof will be omitted. To facilitate description, in FIG. 9, the elements in the right side of the rotation axis SL of the main shaft 17 are designated by reference numerals to which “R” is suffixed, and the elements in the left side of the rotation axis SL are designated by reference numerals to which “L” is suffixed.

As shown in FIG. 8, the tip turbine fan 2 of this embodiment has twelve compressed air intake ports 14 leading to the turbine chamber 15. To each compressed air intake port 14, a compressed air supply passage 6 for supplying compressed air from a compressed air tank 3 to the compressed air intake port 14 is connected. In each compressed air supply passage 6, there is provided an electromagnetic valve 7. The flow of compressed air in each of the compressed air supply passage 6 is controlled in accordance with the degree of opening of the electromagnetic valve 7. The degree of opening of the electromagnetic valve 7 is controlled based on a command from an ECU 5. In this embodiment, the electromagnetic valve 7 constitutes the compressed gas quantity control apparatus according to the present invention.

In the tip turbine fan 2 shown in FIG. 9, the degree of opening of the electromagnetic valve 7R located in the right side of the rotation axis SL is set to full open state, and the degree of opening of the electromagnetic valve 7L in the left side of the rotation axis SL is set to half open state (i.e. the degree of opening being the half of the full open state). In this way, the quantities of compressed air supplied to the turbine chamber 15 through the respective compressed air intake ports 14R, 14L located at symmetrical positions with respect to the rotation axis SL are made different from each other. When the system is arranged in this way, a rotation moment that tilts the rotation axis SL is created by a difference in thrust generated by compressed air exhausted through the compressed air outlet ports opposed to each other with respect to the rotation axis SL, and the left side of the tip turbine fan 2 is lowered while the right side thereof is lifted. This results in a change in the attitude of the vertical take-off and landing aircraft 1 equipped with the tip turbine fan 2.

Since the above-described attitude control of the vertical take-off and landing aircraft 1 is effected by controlling the degree of opening of the electromagnetic valves 7, a relatively high response in attitude control can be realized. The attitude control of the vertical take-off and landing aircraft 1 according to this embodiment is very effective particularly in the case where the attitude control of the vertical take-off and landing aircraft 1 is performed by a so-called cyclic control of the tip turbine 11, which suffers from low responsiveness. In this embodiment, de Laval nozzles 18 are provided at the compressed air outlet ports 16 to improve the efficiency of creation of thrust by the exhaust compressed air.

In controlling the attitude of the vertical take-off and landing aircraft 1, it is possible to control the attitude of the vertical take-off and landing aircraft 1 generally freely by controlling not only the degree of opening of the two electromagnetic valves 7 shown in FIG. 9 but also the degree of opening of a plurality of electromagnetic valves 7 to certain degrees of opening respectively by the ECU 5.

### Embodiment 4

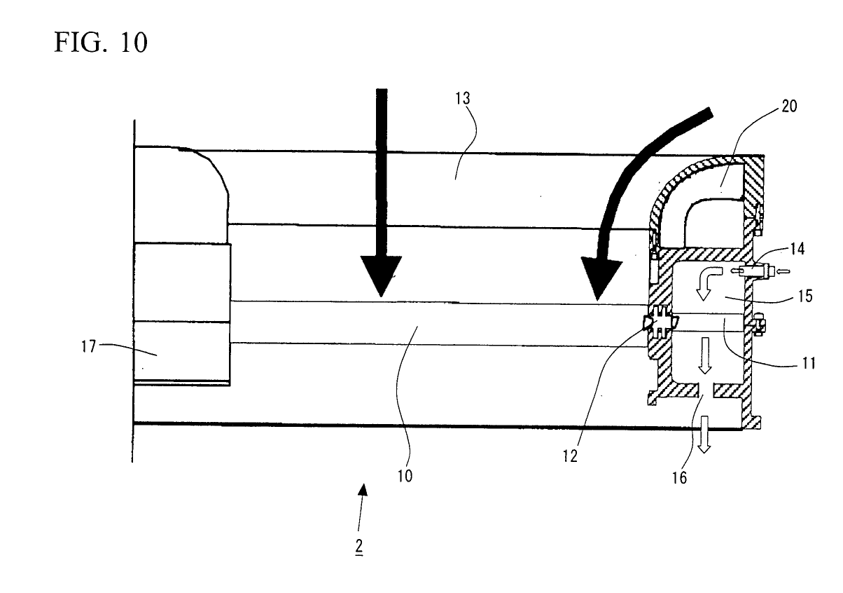

FIG. 10 shows the structure of a tip turbine fan 2 provided in a vertical take-off and landing aircraft 1 according to this embodiment. The elements same as elements of the tip turbine fan 2 shown in FIG. 4 are designated by the same reference numerals, and detailed descriptions thereof will be omitted.

In the tip turbine fan 2 according to this embodiment, a heat insulation portion 20 having a heat insulation effect is provided in the upper portion of the fan case 13 in the vicinity of the turbine chamber 15 all along its circumference. Thanks to this feature, thermal energy in the turbine chamber 15 is hard to leak to the exterior. Thus, the compressed air works in the turbine chamber 15 more efficiently, namely, lift is created in the tip turbine 11 more efficiently. The heat insulation portion 20 may be merely an air layer, or it may be filled with a heat insulating material such as glass fiber mixed with aramid fiber.

By filling the heat insulation portion 20 with a heat insulating material, it is possible to absorb noises generated in the turbine chamber 15 and to protect, in case the tip turbine 11 breaks, the operator HD from the broken tip turbine 11.

### Embodiment 5

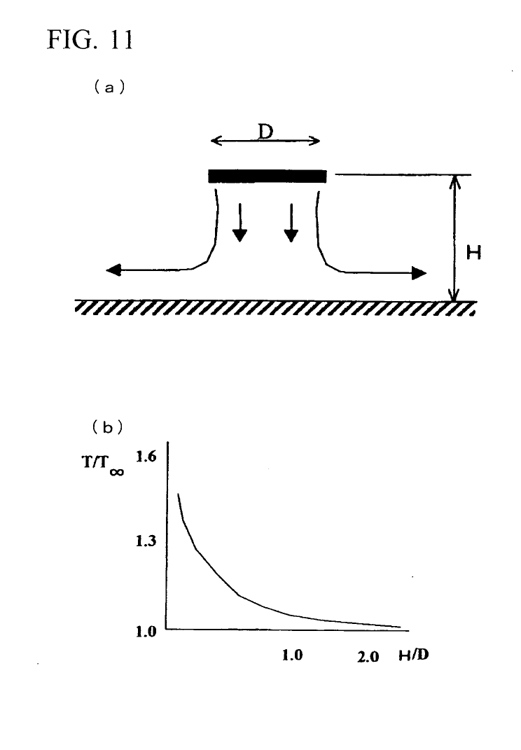

When the vertical take-off and landing aircraft 1 takes off or lands, a large change in the thrust sometimes occurs due to ground effect. Here, a brief description will be made of ground effect with reference to FIG. 11. Ground effect changes in the way shown in FIG. 11(b), where D represents the diameter of the tip turbine fan 2 and H represents the height from the ground as shown in FIG. 11(a). In FIG. 11(b) the horizontal axis represents the ratio H/D of the aforementioned height H and the diameter D of the tip turbine fan 2, and the vertical axis represents the ratio of the thrust when the height of the tip turbine fan 2 from the ground is H and the thrust when the height of the tip turbine fan 2 from the ground is infinity.

As will be seen, the smaller the height of the tip turbine fan 2 from the ground is, the greater ground effect is. In this embodiment, ground effect is particularly outstanding when ratio H/D is smaller than 2.0. The greatness of ground effect implies an abrupt change in thrust acting on the vertical take-off and landing aircraft 1. However, the nature of the tip turbine fan 2 make it difficult to control the tip turbine fan 2 with high responsiveness in accordance with ground effect to stabilize the thrust acting on the vertical take-off and landing aircraft 1.

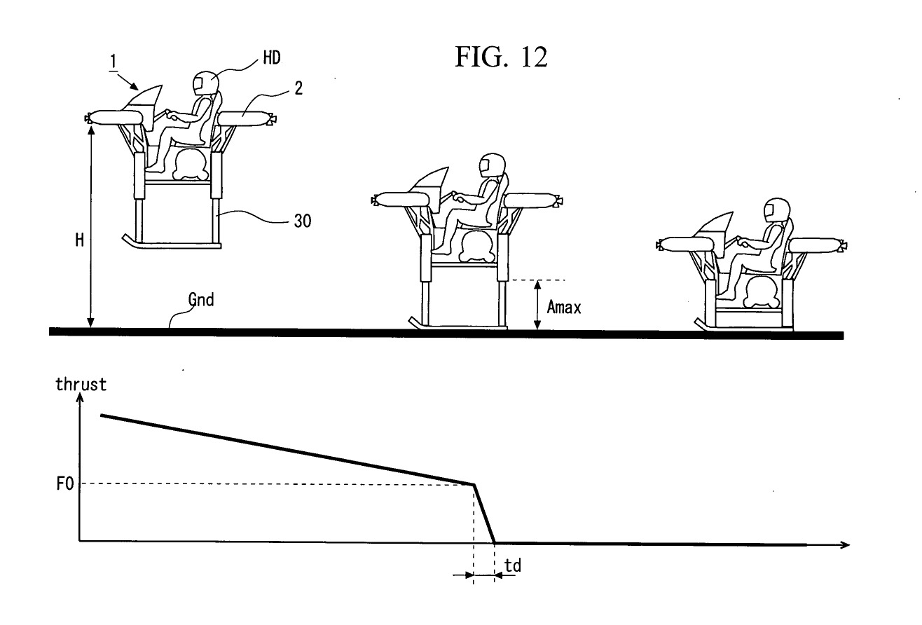

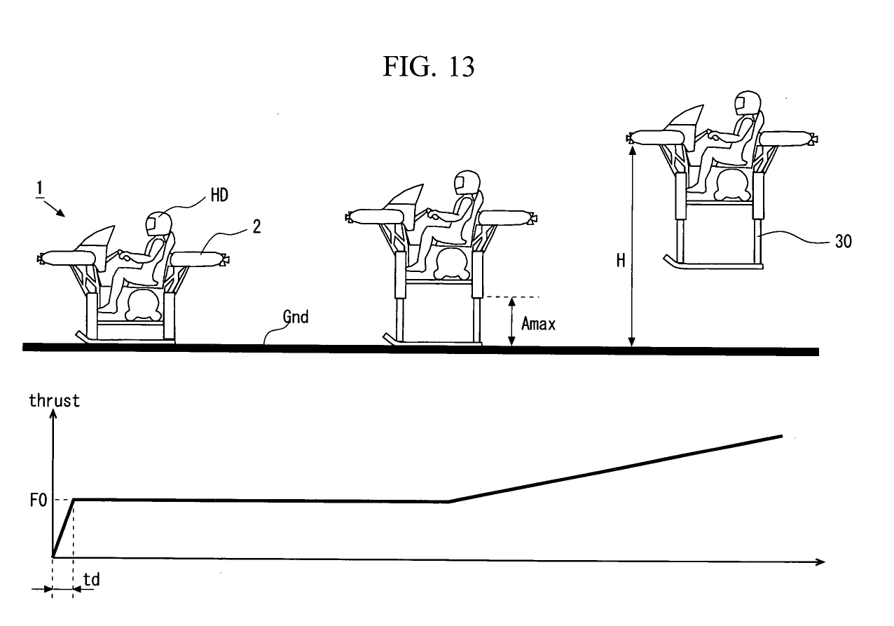

In view of the above, in this embodiment, a retractable and extendable shock absorber 30 is provided on the bottom portion of the vertical take-off and landing aircraft 1 as shown in FIGS. 12 and 13. In addition, the length Amax of the shock absorber 30 at the time when the vertical take-off and landing aircraft 1 comes in contact with the ground Gnd or when it leaves the ground Gnd is designed taking ground effect into consideration. This embodiment will be descried in the following with reference to FIGS. 12 and 13.

In the upper part of FIG. 12, the left drawing illustrates the vertical take-off and landing aircraft 1 in flight, the center drawing illustrates a situation where the vertical take-off and landing aircraft 1 that had been in flight has just come in contact with the ground, and the right drawing illustrates the vertical take-off and landing aircraft 1 in a finally landed, stationary state in which the shock absorber 30 has been shortened after the contact with the ground. The lower part of FIG. 12 shows changes in the thrust of the tip turbine fan 2 in relation to the states of the vertical take-off and landing aircraft shown in the upper part.

In this embodiment, the length Amax of the shock absorber 30 is set to such a value that the ratio H/D becomes 2.0, which is the threshold value distinguishing whether ground effect is outstanding or not, as will be seen from FIG. 11(b). Accordingly, the vertical take-off and landing aircraft 1 in flight comes in contact with the ground in a state in which the length of the shock absorber 30 is Amax, and from that time forward, generation of the thrust of the tip turbine fan 2 is being stopped. Thus, the height of the vertical take-off and landing aircraft 1 is changed to the height in the stationary state by shortening the shock absorber 30. With this feature, it is not necessary to control the thrust of the tip turbine fan 2 in situations where ground effect is outstanding, and therefore stable landing is made possible. The time designated by “td” in FIG. 12 is a delay time that is required for stopping creation of thrust by the tip turbine fan 2, and the thrust designated by “F0” in FIG. 12 is the thrust equivalent to the weight of the vertical take-off and landing aircraft 1. This also applies to FIG. 13 that will be referred to below.

In the upper part of FIG. 13, the left drawing illustrates a landed, stationary state, the center drawing illustrates a situation where the vertical take-off and landing aircraft 1 that had been in a landed state is about to leave the ground, and the right drawing illustrates the vertical take-off and landing aircraft 1 in flight. The lower part of FIG. 13 shows changes in the thrust of the tip turbine fan 2 in relation to the states of the vertical take-off and landing aircraft shown in the upper part.

When the vertical take-off and landing aircraft 1 is stationary on the ground Gnd, thrust equal to F0 is generated as long as it is in contact with the ground. The shock absorber 30 is extended until its length becomes Amax. When the length of the shock absorber 30 reaches Amax, ascending force is provided by the thrust of the tip turbine fan 2 to thereby achieve flight. Thus, flight by the tip turbine fan 2 is started after ground effect has become insignificant. Therefore, it is not necessary to control the thrust of the tip turbine fan 2 in accordance with ground effect in situations where ground effect is outstanding. Thus, stable take-off is made possible.

Although in this embodiment, the length Amax of the shock absorber 30 is set, taking into ground effect into consideration, in such a way that ratio H/D becomes 2.0, the length may be changed fitly taking into consideration ground effect that works in actual vertical take-off and landing aircrafts.

According to the present invention, in a vertical take-off and landing aircraft that uses as a source of thrust tip turbine fans, it is possible to reduce the degree of non-uniformity in the temperature distribution in the tip turbine fan, to stabilize the attitude of the vertical take-off and landing aircraft upon stoppage of one tip turbine fan, and to control the attitude of the vertical take-off and landing aircraft with high responsiveness.

While the invention has been described in terms of preferred embodiments, those skilled in the art will recognize that the invention can be practiced with modifications within the spirit and scope of the appended claims.

What is claimed is:

1. A vertical take-off and landing aircraft provided with a tip turbine fan in which a fan is rotated by blowing, in an annular turbine chamber provided around a rotation shaft of the fan at the center, compressed gas to a tip turbine attached to the fan to enable vertical take-off and landing,
wherein three or more compressed gas intake ports for supplying compressed gas to said turbine chamber are provided at regular intervals along the circumference of the turbine chamber.

2. A vertical take-off and landing aircraft provided with a plurality of tip turbine fans in each of which a fan is rotated by blowing, in an annular turbine chamber provided around a rotation shaft of the fan at the center, compressed gas to a tip turbine attached to the fan to enable vertical take-off and landing,
wherein in each of said plurality of tip turbine fans, an even number of sets of fans and tip turbines are provided, said plurality of tip turbines being arranged in series along the flow of compressed gas in the turbine chamber, and rotation directions of the fans to which the respective tip turbines are attached being alternately opposite.

3. A vertical take-off and landing aircraft according to claim 2, wherein, in each of said tip turbine fans, the more downstream a tip turbine, among said multiple tip turbines, is located in the gas flow in said turbine chamber, the larger the angle of attack between that tip turbine and the compressed gas flow is.

4. A vertical take-off and landing aircraft provided with a tip turbine fan in which a fan is rotated by blowing, in an annular turbine chamber provided around a rotation shaft of the fan at the center, compressed gas to a tip turbine attached to the fan to enable vertical take-off and landing,
wherein a plurality of compressed gas intake ports for supplying compressed gas to said turbine chamber are provided along the circumference of the turbine chamber;
compressed gas outlet ports corresponding to said compressed gas intake ports for discharging compressed gas in the turbine chamber are provided on the turbine chamber; and comprising:
compressed gas quantity control apparatuses that control the quantity of compressed gas supplied to said turbine chamber through said plurality of compressed gas intake ports respectively.

5. A vertical take-off and landing aircraft according to claim 4, further comprising:
a compressed gas tank that stores compressed gas; and
compressed gas supply passages one end of each of which is connected to said compressed gas tank, and the other end of each of which is connected to each of said compressed gas intake ports, for supplying compressed gas from said compressed gas tank to said compressed gas intake port,
wherein each of said compressed gas control apparatuses has a compressed gas control valve which is provided in each of said compressed gas supply passages for controlling compressed gas flow in the compressed gas flow supply passage.

6. A vertical take-off and landing aircraft according to claim 4, wherein a de Laval nozzle is provided at said compressed gas outlet port.
